(19) United States
(12) Patent Application Publication
(10) Pub. No.: US 2011/0047687 A1
(43) Pub. Date: Mar. 3, 2011

(54) Apparatus and Method for Providing a Hygienic Toilet Seat

(76) Inventors: Jeong-Hee Lee, Cupertino, CA (US); Samuel Seungmin Cho, Fremont, CA (US)

(21) Appl. No.: 12/552,287

(22) Filed: Sep. 2, 2009

(51) Int. Cl. A47K 13/10; G08B 21/00

(52) U.S. Cl. 4/246.1; 340/540

(57) ABSTRACT

A hygienic toilet alert system and a method for providing a hygienic toilet seat are disclosed. In one embodiment of the invention, the hygienic toilet alert system is capable of reminding a user to either raise or lower a toilet seat based on sensor feedback from a toilet seat position sensor and at least one additional sensing device, which may be a flush sensor, a proximity sensor, and/or a foot-position sensor. Furthermore, in one embodiment of the invention, the hygienic toilet alert system is also capable of providing a motorized movement of the toilet seat based on the sensor feedback. Various methods of providing the hygienic toilet seat based on the sensor feedback are also disclosed in accordance with one or more embodiments of the invention.

### BACKGROUND OF THE INVENTION

The present invention generally relates to a toilet seat device. More specifically, the invention relates to one or more apparatuses and methods for providing a hygienic toilet seat by incorporating novel alert and/or movement features based on one or more input variables. Some examples of the one or more input variables include, but are not limited to, a current position of a toilet seat, a current position of a user, and a current operational status of a toilet.

A flush-based toilet device is generally a necessity in a modern bathroom today. Recent social emphasis on personal and public hygiene has created a myriad of toilet-related attachments and/or devices for users' hygiene and/or convenience. Some examples of toilet-related attachments and/or devices include proximity-sensor based flush bathroom stalls in a men's bathroom, motorized toilet seats, and sophisticated bidets capable of sanitizing relevant body parts and toilet bowls. Although some of these systems are implemented in public bathrooms and commercial buildings, many residential house bathrooms still have not rapidly adopted these innovations as a standard or common feature. Instead of being equipped with motorized toilet seats and electronic bidets, a typical residential house bathroom has a manually-operated toilet which requires a person's hand to change a toilet seat's position and to trigger a flushing operation.

One reason for a lack of motorized toilet seats and electronic bidets as a common feature in a residential house bathroom is due to a relatively high cost of installation of such devices. Another reason for the lackluster use of motorized toilet seats, electronic bidets, and other toilet-related accessories in residential house bathrooms may be due to a multi-gender and multi-age-group usage of the bathroom. For example, a boy or a girl using the toilet may not use the motorized toilet seat or the electronic bidet properly and potentially cause inconvenience, safety, and/or hygienic issues in a residential house bathroom. Furthermore, the operational complexity of using motorized toilet seats and electronic bidets on a daily basis may not justify the cost of purchase and installation for such devices for many consumers. In addition, time and effort required for maintenance and cleaning of motorized toilets seats and/or electronic bidets in residential house bathrooms may not appeal to consumers.

Nevertheless, some cost-effective toilet-related devices which improve convenience and hygienic maintenance of residential household bathrooms may still appeal to consumers. In particular, cost-effective toilet-related devices which are designed to provide a higher level of convenience and hygiene in a multi-gender and multi-age-group usage of toilets may become popular in residential homes, either as a standard feature or as an add-on aftermarket feature.

Although existing motorized toilet seats and/or electronic bidets in the market today provide varying levels of hygienic convenience to users, their relatively high cost of production, difficulty of installation and maintenance, and multi-gender and multi-age-group usage environment have kept many consumers from installing these devices in home bathrooms. Accordingly, one or more novel apparatuses and one or more novel methods for providing simple and inexpensive improvement to user convenience and hygiene in a residential house toilet system is highly desirable.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a hygienic toilet alert system configured to inform a user to change a current position of a toilet seat is disclosed. The hygienic toilet alert system comprises a toilet seat position sensor configured to detect the current position of the toilet seat, wherein the toilet seat position sensor is operatively connected to a main system unit; an additional sensing device capable of sensing a flushing operation and a status related to the flushing operation, a nearby user up to a threshold distance, and/or a user's particular foot position, wherein the additional sensing device may be a flush sensor, a proximity sensor, and/or a foot-position mattress with one or more foot-position sensors; and the main system unit operatively connected to the toilet seat position sensor and the additional sensing device, wherein the main system unit is capable of analyzing information from the toilet seat position sensor and the additional sensing device to determine whether an aural alert needs to be generated to inform the user to change the current position of the toilet seat.

Furthermore, in one embodiment of the invention, a method for providing a hygienic toilet seat is disclosed. This method comprises the steps of using a flush sensor to detect a flush operation initiated by a user, detecting a current position of a toilet seat using a toilet seat position sensor, and if the toilet seat is not at a completely-raised position: generating an aural alert such as a chime, a bell, and/or a voice message to remind the user to raise the toilet seat to a completely-raised position.

In addition, in one embodiment of the invention, another method for providing a hygienic toilet seat is disclosed. This method comprises the steps of: using a proximity sensor to detect presence of a user up to a threshold distance, wherein the threshold distance may be adjustable by the user; and if the user is staying within the threshold distance past a trigger-wait time and then moved outside the threshold distance some time after the trigger-wait time: checking whether the toilet seat is at a completely-raised position; and if the toilet seat is not at the completely-raised position: generating an aural alert such as a chime, a bell, and/or a voice message to remind the user to raise the toilet seat to the completely-raised position.

Moreover, in one embodiment of the invention, another method for providing a hygienic toilet seat is disclosed. This method comprises the steps of: using a foot-position sensor to detect presence of a user's foot and a user's toe orientation; and if the user on the foot-position sensor is past a trigger-wait time and if the user's toes point towards a toilet base: checking whether the toilet seat is at a completely-raised position; and if the toilet seat is not at the completely-raised position: generating an aural alert such as a chime, a bell, and/or a voice message to remind the user to raise the toilet seat to the completely-raised position.

Furthermore, in one embodiment of the invention, another method for providing a hygienic toilet seat is disclosed. This method comprises the steps of: using a foot-position sensor to detect presence of a user's foot and a user's toe orientation; and if the user on the foot-position sensor is past a trigger-wait time and if the user's toes point towards a toilet base: checking whether the toilet seat is at a completely-raised position; and if the toilet seat is not at the completely-raised position: raising the toilet seat and/or a toilet bowl cover to the completely-raised position by using a toilet seat motor; else if the user on the foot-position sensor is past the trigger-wait time and if the user's toes point away from the toilet base: checking whether the toilet seat is at a completely-lowered position; and if the toilet seat is not at the completely-lowered position: lowering the toilet seat and/or the toilet bowl cover to the completely-lowered position by using the toilet seat motor.

### BRIEF DESCRIPTION OF DRAWINGS

FIG. 1 shows a frontal perspective view of a hygienic toilet seat alert system with a flush sensor and a toilet seat position sensor installed on a toilet, in accordance with an embodiment of the invention.

FIG. 2 shows a perspective view of a hygienic toilet seat alert system with a battery casing, a flush sensor, and a toilet seat position sensor, in accordance with an embodiment of the invention.

FIG. 3 shows an embodiment of a hygienic toilet seat alert system with an electrical power cord, a flush sensor, and a toilet seat position sensor, in accordance with an embodiment of the invention.

FIG. 4 shows a method of providing a hygienic toilet seat with a flush sensor and a toilet seat position sensor, in accordance with an embodiment of the invention.

FIG. 5 shows a frontal perspective view of a hygienic toilet seat alert system with a proximity sensor and a toilet seat position sensor installed on or near a toilet, in accordance with an embodiment of the invention.

FIG. 6 shows a perspective view of a hygienic toilet seat alert system with a battery casing, a toilet seat position sensor, and a proximity sensor, in accordance with an embodiment of the invention.

FIG. 7 shows a perspective view of a hygienic toilet seat alert system with an electrical power cord, a toilet seat position sensor, and a proximity sensor, in accordance with an embodiment of the invention.

FIG. 8 shows a perspective view of a hygienic toilet seat alert system with a battery casing, a toilet seat position sensor, and an integrated proximity sensor in a system main unit, in accordance with an embodiment of the invention.

FIG. 9 shows a perspective view of a hygienic toilet seat alert system with an electrical power cord, a toilet seat position sensor, and an integrated proximity sensor in a system main unit, in accordance with an embodiment of the invention.

FIG. 10 shows a method of providing a hygienic toilet seat with a proximity sensor and a toilet seat position sensor, in accordance with an embodiment of the invention.

FIG. 11 shows a frontal perspective view of a hygienic toilet seat alert system with a foot-position mattress and a toilet seat position sensor, in accordance with an embodiment of the invention.

FIG. 12 shows a method of providing a hygienic toilet seat with a foot position mattress and a toilet seat position sensor, in accordance with an embodiment of the invention.

FIG. 13 shows a frontal perspective view of a hygienic toilet seat alert system with a foot-position mattress, a toilet seat motor, and a toilet seat position sensor, in accordance with an embodiment of the invention.

FIG. 14 shows a method of providing a motorized hygienic toilet seat with a foot-position mattress, a toilet seat motor, and a toilet seat position sensor, in accordance with an embodiment of the invention.

FIG. 15 shows an illustrative example of a user standing on top of a foot-position mattress with the user's toes pointing towards a toilet base, in accordance with an embodiment of the invention.

FIG. 16 shows an illustrative example of a user standing on top of a foot-position mattress with the user's toes pointing away from a toilet base, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more apparatuses and methods for providing one or more hygienic toilet seats. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order and do not imply any limitations in the invention.

One objective of the present invention is to provide a hygienic toilet seat as a standard feature or as an aftermarket add-on installation, wherein the hygienic toilet seat comprises a toilet seat position sensor and at least one other sensing device (e.g. a flush sensor, a proximity sensor, and/or a foot-position mattress with one or more foot-position sensors). Another objective of the present invention is to provide a hygienic toilet seat which reduces chances of accidental urination (i.e. especially by a male user) while a toilet seat is in a lowered position. Yet, another objective of the present invention is to provide a hygienic and convenient toilet user experience regardless of which age group or gender a user belongs to. Furthermore, at least in one embodiment of the invention, an additional objective of the present invention is to provide a motorized toilet system with a fully-automatic movement of a toilet seat based on a presence and a position of user's toes.

For the purpose of describing the invention, a term “toilet” is defined as a bathroom fixture which typically comprises a water-flushed bowl and a seat, wherein the bathroom fixture is used for defecation and urination.

Furthermore, for the purpose of describing the invention, a term “hygienic” is defined as exhibiting at least some degree of cleanliness or sanitizing effects.

In addition, for the purpose of describing the invention, a term “flush” and its related terms, “flushing” and “flushing operation” are defined as cleansing an object (e.g. a toilet bowl) with a gush of liquid.

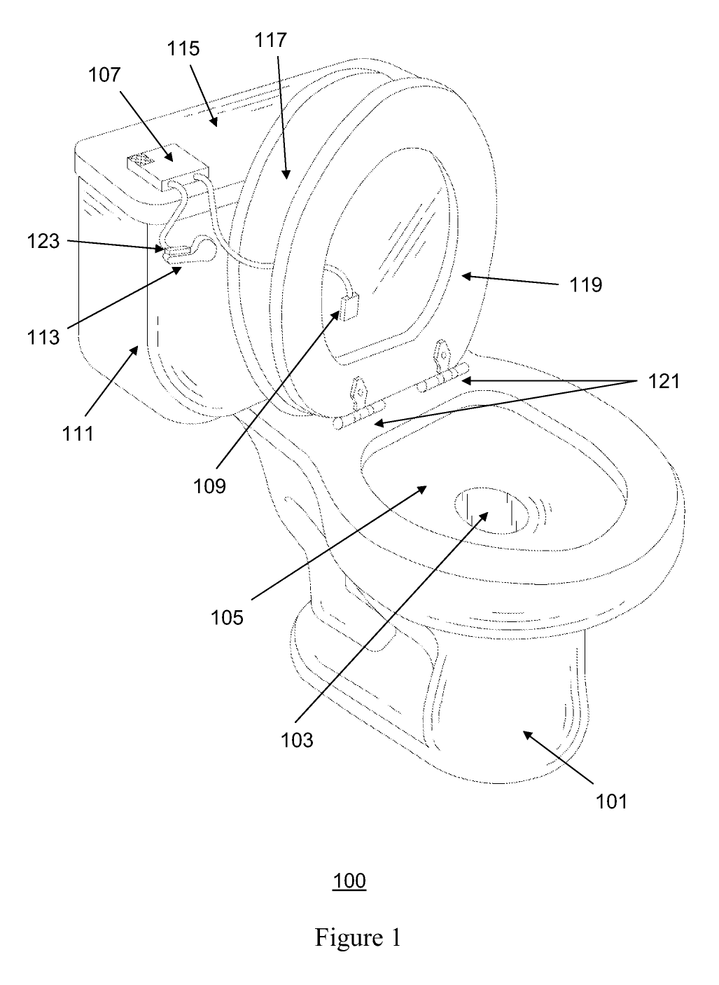

FIG. 1 shows a frontal perspective view of a hygienic toilet seat alert system with a flush sensor (123) and a toilet seat position sensor (109) installed on a toilet (100), in accordance with an embodiment of the invention. In a preferred embodiment of the invention, a main system unit (107) of the hygienic toilet seat alert system is configured to receive, analyze, and/or process information from one or more sensors (123, 109) operatively connected to the main system unit (107). The main system unit (107) typically contains one or more electrical logic blocks on one or more semiconductor chips, wherein the one or more electrical logic blocks may be able to regulate and provide operating power to the one or more sensors (123, 109), control functions of the hygienic toilet seat alert system, and/or generate an aural alert if necessary. In one embodiment of the invention as shown in FIG. 1, the main system unit (107) is operatively connected to a toilet seat position sensor (109). The toilet seat position sensor (109) is designed to detect a current position of a toilet seat (119), which may be at a completely-raised position, a completely-lowered position, or somewhere in between. In one embodiment of the invention, the toilet seat position sensor (109) may contain a proximity sensor capable of detecting how close or how far the toilet seat (119) is currently positioned relative to a location of the toilet seat position sensor (109).

In another embodiment of the invention, the toilet seat position sensor (109) may simply be a physical contact sensor such as a “push switch”, wherein a position of the toilet seat (119) is detected by a physical contact of the toilet seat position sensor (109) and another object, such as a portion of the toilet seat (119) itself or another object. For example, the toilet seat position sensor (109) can be a “push switch” which may be attached to a lower surface of the toilet seat (119) to detect a change in weight of the toilet seat (119). In one embodiment of the invention, this push switch may have two levels of weight-sensing. In a first level of weight-sensing, if the push switch (i.e. as a toilet seat position sensor (109)) is simply supporting a weight of the toilet seat (119) and/or the toilet bowl cover (117), then the main system unit (107) may recognize the weight of the toilet seat (119) and/or the toilet bowl cover (117) as a “completely-lowered” position without an additional human weight. In general, the hygienic toilet alert system is active if the first level of weight-sensing is detected, because a user is not sitting on top of the toilet seat (119). On the other hand, in a second level of weight-sensing, if the push switch (i.e. as a toilet seat position sensor (109)) is supporting the weight of the toilet seat (119) and/or the toilet bowl cover (117) as well as the additional human weight, the hygienic toilet alert system may go to an inactive mode as long as the second level of weight-sensing is present, because the user is actually sitting on top of the toilet seat (119). In the second level of weight-sensing using a push switch as a toilet seat position sensor (109), a toilet seat position warning may not be necessary.

Moreover, if the toilet seat position sensor (109) uses a push switch as described above in one embodiment of the invention, the toilet seat position sensor (109) can further incorporate a tilt sensor which can detect a current tilt angle of the toilet seat (119). In this particular embodiment of the invention, the tilt sensor allows the main system unit (107) to determine whether a toilet seat (119) and/or a toilet bowl cover (1 17) are lowered or raised. The tilt sensor and the push switch can also be designed as embedded units in a toilet seat (119) and/or a toilet bowl cover (117).

Furthermore, the main system unit (107) can also be operatively connected to an additional sensing device. In one embodiment of the invention as shown in FIG. 1, the additional sensing device is a flush sensor (123) located near or on top of a flush lever (113). The flush sensor (123) is designed to detect a flushing operation of the toilet (100) or a status related to the flushing operation of the toilet (100). Examples of the status related to the flushing operation include, but are not limited to, a completion of the flushing operation, a malfunction of the flushing operation, and/or a triggering of the flushing operation. In a preferred embodiment of the invention, the flush sensor (123) may comprise a touch sensor which detects a human finger contact of the flushing sensor (123) located on top of the flush lever (113). In another embodiment of the invention, the flush sensor (123) may comprise a combination of a touch sensor, a water-level sensor designed to detect a current water level in a water tank (111), and/or a drain flow sensor designed to detect a current flow of liquid in a drain.

The toilet seat position sensor (109) and the flush sensor (123) may be physically connected by wires or wirelessly connected with the main system unit (107). In a preferred embodiment of the invention, the flush sensor (123) is on top of the flush lever (113), wherein the flush lever is designed to trigger a flushing operation of the toilet (100). Furthermore, in a preferred embodiment of the invention, the toilet seat position sensor (109) is attached to a surface of a toilet bowl cover (117). In an alternate embodiment of the invention, the toilet seat position sensor (109) may be attached to a surface of the toilet seat (119) itself or another surface near toilet seat hinges (121).

Continuing with FIG. 1, the main system unit (107) of the hygienic toilet seat alert system can be powered by batteries or electrical power source (e.g. alternate current (AC), direct current (DC)) through a power cord and an electrical outlet. In one embodiment of the invention, the main system unit (107) can also contain an integrated speaker designed to generate an aural alert when the main system unit (107) determines that a change of a current position of the toilet seat (109) is desired. In another embodiment of the invention, the main system unit (107) may simply be operatively connected to an external speaker, which is also capable of generating an aural alert when the main system unit (107) similarly determines that a change of a current position of the toilet seat (109) is desired.

For the embodiment of the invention as shown in FIG. 1, the toilet (100) also has a toilet base (101) which structurally supports a toilet drain (103) and a toilet bowl (105). In one embodiment of the invention, the toilet drain (103) removes water contained by the toilet bowl (105) when a flushing operation is triggered, typically by a user pressing the flush lever (113). The toilet (100) also typically contains a water tank (111) which typically reserves a certain amount of fresh water. The water tank (111) is designed to release and send the fresh water into the toilet bowl (105) if a flushing operation is triggered, while an existing water puddle on the toilet bowl (105) is drained out through the toilet drain (103). A top portion of the water tank (111) is typically protected and enclosed by a water tank cover (115). In a preferred embodiment of the invention, the main system unit (107) of the hygienic toilet seat alert system is attached to a top surface of the water tank cover (115).

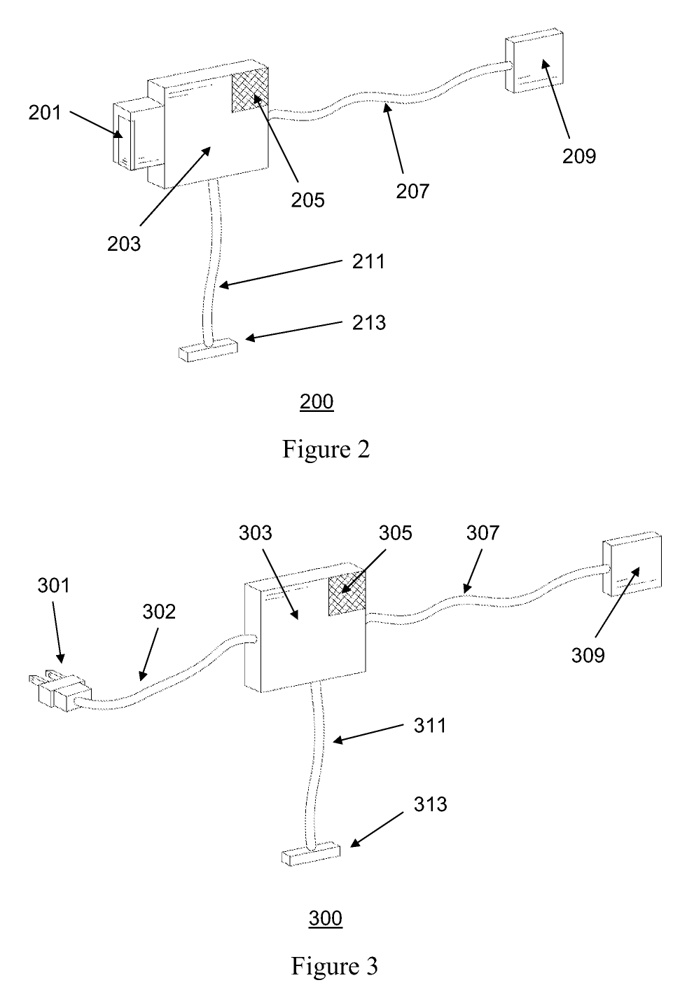

FIG. 2 shows a perspective view of a hygienic toilet seat alert system (200) with a battery casing (201), a flush sensor (213), and a toilet seat position sensor (209) which are operatively connected to the main system unit (203), in accordance with an embodiment of the invention. In a preferred embodiment of the invention, the battery casing (201) is capable of containing one or more batteries to provide an electrical power to the main system unit (203), the flush sensor (213), and the toilet seat position sensor (209). In one embodiment of the invention, the flush sensor (213) and/or the toilet seat position sensor (209) may be connected to the main system unit (203) through electrical wires (e.g. a first electrical wire (207) between the main system unit (203) and the toilet seat position sensor (209), a second electrical wire (211) between the main system unit (203) and the flush sensor (213), and etc.). In another embodiment of the invention, the flush sensor (213) and/or the toilet seat position sensor (209) may be wirelessly connected to the main system unit (203). In a preferred embodiment of the invention, a system speaker (205) capable of generating an aural alert is integrated into a casing of the main system unit (203) for the hygienic toilet seat alert system (200).

FIG. 3 shows an embodiment of a hygienic toilet seat alert system (300) with an electrical power cord (301), a flush sensor (313), and a toilet seat position sensor (309), which are operatively connected to a main system unit (303) in accordance with an embodiment of the invention. In a preferred embodiment of the invention, the electrical power cord (301) is configured to be plugged into an AC (alternate current) or DC (direct current) power source, such as an electrical outlet, and supplies power to the main system unit (303) through a power cord line (302). In one embodiment of the invention, the AC power source from an electrical outlet is converted into a direct current (DC) before electrical power is supplied into the main system unit (303) and/or digital logic blocks inside the main system unit (303). In another embodiment of the invention, the main system unit (303) has an integrated AC-to-DC converter and uses the converted DC current for powering at least some portions of the main system unit (303).

In one embodiment of the invention, the flush sensor (313) and/or the toilet seat position sensor (309) may be connected to the main system unit (303) through electrical wires (e.g. a first electrical wire (307) between the main system unit (303) and the toilet seat position sensor (309), a second electrical wire (311) between the main system unit (303) and the flush sensor (313), and etc.). In another embodiment of the invention, the flush sensor (313) and/or the toilet seat position sensor (309) may be wirelessly connected to the main system unit (303). In a preferred embodiment of the invention, a system speaker (305) capable of generating an aural alert is integrated into a casing of the main system unit (303) for the hygienic toilet seat alert system (300).

Although a hygienic toilet seat alert system (e.g. 200, 300) with a toilet seat position sensor and a flush sensor may utilize a battery-powered configuration as shown in FIG. 2, or an AC/DC powered configuration as shown in FIG. 3, it is also possible to design a hygienic toilet seat alert system which uses both the battery-powered configuration and the AC/DC powered configuration in one system.

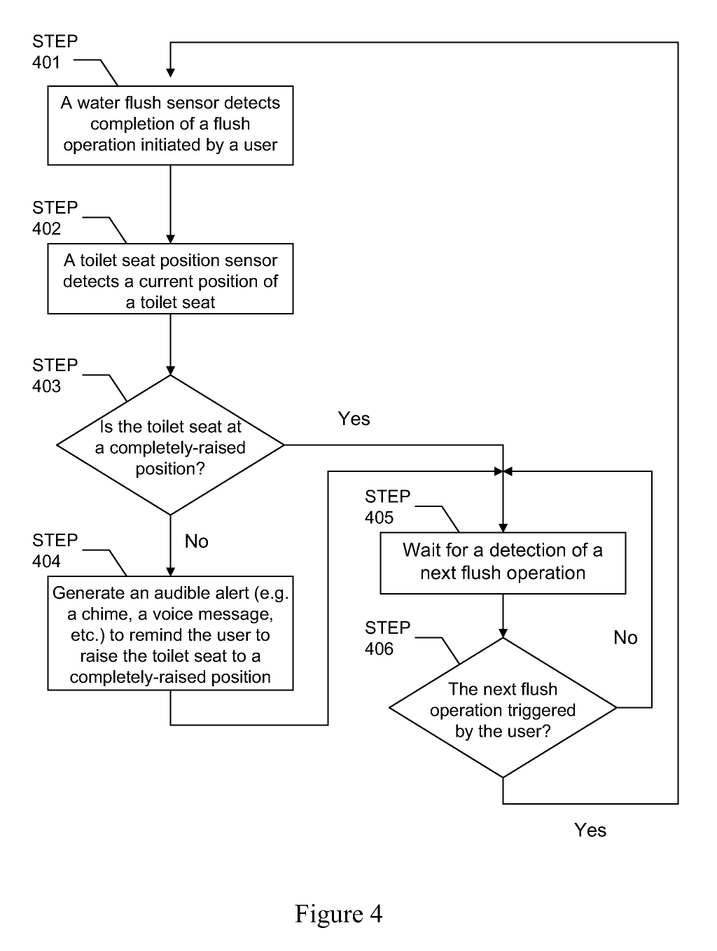

FIG. 4 shows a method of providing a hygienic toilet seat with a flush sensor and a toilet seat position sensor, in accordance with an embodiment of the invention. In a preferred embodiment of the invention as shown in FIG. 4, a water flush sensor detects an initialization, an ongoing progress, and/or a completion of a flush operation initiated by a user, as shown in STEP 401. The water flush sensor typically sends a signal to a main system unit of a hygienic toilet seat alert system to inform a new status of the flushing operation. Then, in STEP 402, a toilet seat position sensor detects and/or confirms a current position of a toilet seat and sends a relevant signal to the main system unit of the hygienic toilet seat alert system. The hygienic toilet seat alert system is now ready to determine whether the toilet seat is at a completely-raised position, as shown in STEP 403. If the toilet seat is not at the completely-raised position, then the hygienic toilet seat alert system generates an audible alert such as a chime, a voice message, and/or a bell to remind the user to raise the toilet seat to a completely-raised position, as shown in STEP 404. On the other hand, if the toilet seat is already at the completely raised position or if the audible alert generation is complete, then the hygienic toilet seat alert system waits for a detection of a next flush operation, as shown in STEP 405. If a next flush operation is triggered by the user, as shown in STEP 406, then the previous steps (e.g. STEP 401 403) of detecting the flush operation and the current position of the toilet seat are reiterated for subsequent operations, as shown in FIG. 4. If the next flush operation is not yet triggered by the user, then the toilet seat alert system can simply continue to wait (e.g. STEP 405) for a next flush operation.

In its simplest form, the present invention is configured to alert a user to raise a toilet seat to a completely-raised position if the toilet seat is not raised after a flush operation. The reason for this alert is to minimize accidental chances of male users' urination to a toilet bowl when a toilet seat is not completely raised up. By alerting users to place the toilet seat to a completely-raised position after a flush operation, the toilet seat alert system minimizes chances of a male user spilling urine on an upper surface of the toilet seat. This embodiment of the toilet seat alert system is especially effective in households with male children, because a male child often forgets to raise the toilet seat before urination. By installing a novel, cost-effective, and simple alerting device which uses sensor feedback from a toilet seat position sensor and a flush sensor, a residential house bathroom can achieve a high level of hygiene in toilet operation and maintenance.

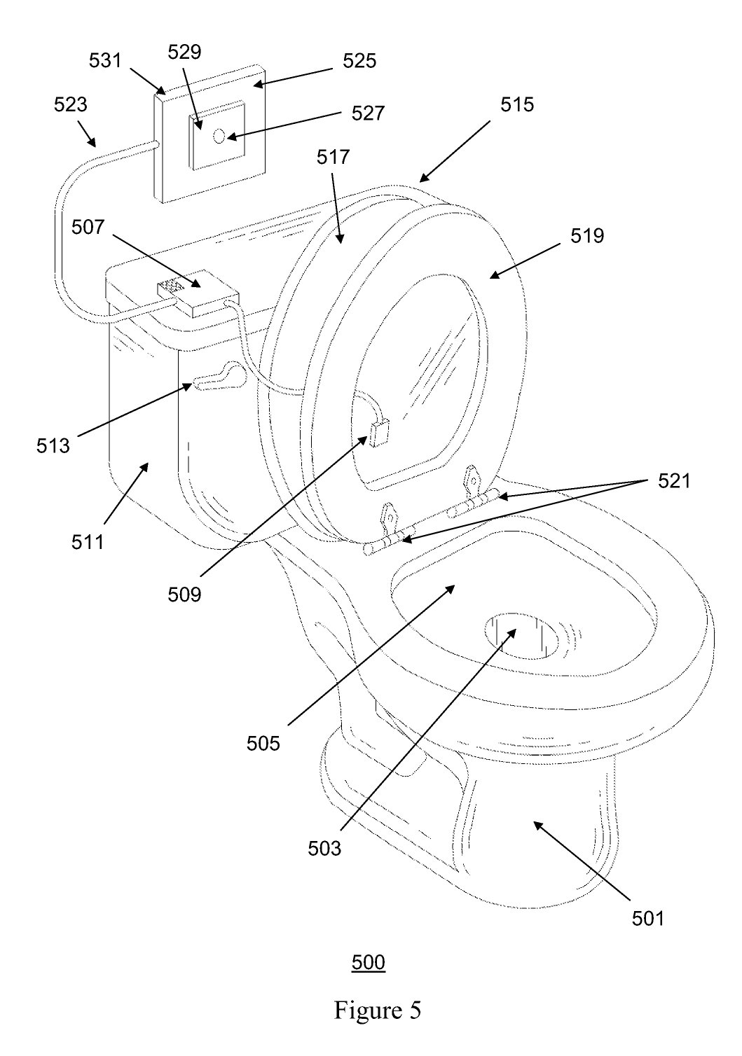

FIG. 5 shows a frontal perspective view of a hygienic toilet seat alert system with a proximity sensor (531) and a toilet seat position sensor (509) installed on or near a toilet (500), which are operatively connected to a main system unit (507) of the hygienic toilet seat alert system, in accordance with an embodiment of the invention. In a preferred embodiment of the invention, a main system unit (507) of the hygienic toilet seat alert system is configured to receive, analyze, and/or process information from one or more sensors (509, 531) operatively connected to the main system unit (507). The main system unit (507) typically contains one or more electrical logic blocks on one or more semiconductor chips, wherein the one or more electrical logic blocks may be able to regulate and provide operating power to the one or more sensors (509, 531), control functions of the hygienic toilet seat alert system, and/or generate an aural alert if necessary. In one embodiment of the invention as shown in FIG. 5, the main system unit (507) is operatively connected to a toilet seat position sensor (509). The toilet seat position sensor (509) is designed to detect a current position of a toilet seat (519), which may be at a completely-raised position, a completely-lowered position, or somewhere in between. In one embodiment of the invention, the toilet seat position sensor (509) may contain a proximity sensor capable of detecting how close or how far the toilet seat (519) is currently positioned relative to a location of the toilet seat position sensor (509).

In another embodiment of the invention, the toilet seat position sensor (509) may simply be a physical contact sensor, wherein a position of the toilet seat (519) is detected by a physical contact of the toilet seat position sensor (509) and another object, such as a portion of the toilet seat (519) itself or another object. For example, the toilet seat position sensor (509) can be a “push switch” which may be attached to a lower surface of the toilet seat (519) to detect a change in weight of the toilet seat (519). In one embodiment of the invention, this push switch may have two levels of weight-sensing. In a first level of weight-sensing, if the push switch (i.e. as a toilet seat position sensor (509)) is simply supporting a weight of the toilet seat (519) and/or the toilet bowl cover (517), then the main system unit (507) may recognize the weight of the toilet seat (519) and/or the toilet bowl cover (517) as a “completely-lowered” position without an additional human weight. In general, the hygienic toilet alert system is active if the first level of weight-sensing is detected, because a user is not sitting on top of the toilet seat (519). On the other hand, in a second level of weight-sensing, if the push switch (i.e. as a toilet seat position sensor (509)) is supporting the weight of the toilet seat (519) and/or the toilet bowl cover (517) as well as the additional human weight, the hygienic toilet alert system may go to an inactive mode as long as the second level of weight-sensing is present, because the user is actually sitting on top of the toilet seat (519). In the second level of weight-sensing using a push switch as a toilet seat position sensor (509), a toilet seat position warning may not be necessary.

Moreover, if the toilet seat position sensor (509) uses a push switch as described above in one embodiment of the invention, the toilet seat position sensor (509) can further incorporate a tilt sensor which can detect a current tilt angle of the toilet seat (519). In this particular embodiment of the invention, the tilt sensor allows the main system unit (507) to determine whether a toilet seat (519) and/or a toilet bowl cover (517) are lowered or raised. The tilt sensor and the push switch can also be designed as embedded units in a toilet seat (519) and/or a toilet bowl cover (517).

Furthermore, the main system unit (507) can also be operatively connected to an additional sensing device. In one embodiment of the invention as shown in FIG. 5, the additional sensing device is a user proximity sensor (531) which is typically attached to a wall or an object near the toilet (500). In a preferred embodiment of the invention, the user proximity sensor (531) comprises a proximity detector (529), a proximity sensor operational indicator (527), and a proximity sensor frame (525). The proximity detector (529) is generally capable of sensing an approaching or nearby objective up to a preset threshold distance. The proximity detector (529) may comprise an infrared sensing mechanism, a laser or optical distance-measurement-based sensing mechanism, or other available mechanisms for detecting an approaching object. In one embodiment of the invention, a threshold distance may be adjusted through a user interface (e.g. a knob, a switch, a software-driven touch-sensitive display screen, and etc.), wherein the adjustment of the threshold distance may involve changing detection sensitivities of the proximity detector (529). The proximity sensor operational indicator (527) typically indicates whether an object is currently within a threshold distance of detection or not. For example, if the proximity operational indicator (e.g. an light-emitting diode) is “on”, then the indicator may signify that a nearby object is detected within the threshold distance. If the proximity operational indicator is “off”, then the indicator may signify that no object of interest is detected within the threshold distance. In a preferred embodiment of the invention, both the proximity detector (529) and the proximity sensor operational indicator (527) are surrounded by a proximity sensor frame (525), which may be made out of plastic, rubber, or one or more metals. In one embodiment of the invention, the proximity sensor frame (525) provides an aesthetic benefit to an overall design of the user proximity sensor (531). The proximity sensor frame (525) may also provide a structural strength and/or integrity to other components (e.g. 527, 529) surrounded by the proximity sensor frame (525).

The toilet seat position sensor (509) and the user proximity sensor (531) may be physically connected by wires or wirelessly connected with the main system unit (507). In a preferred embodiment of the invention, the user proximity sensor (531) is installed on a wall near the toilet (500), as shown in FIG. 5. In another embodiment of the invention, the user proximity sensor (531) may be integrated into the main system unit. Yet in another embodiment of the invention, the user proximity sensor (531) may be installed separately on top of a water tank cover (515) or another object nearby. Furthermore, in a preferred embodiment of the invention, the toilet seat position sensor (509) is attached to a surface of a toilet bowl cover (517). In an alternate embodiment of the invention, the toilet seat position sensor (509) may be attached to a surface of the toilet seat (519) itself or another surface near toilet seat hinges (521).

Continuing with FIG. 5, the main system unit (507) of the hygienic toilet seat alert system can be powered by batteries or electrical power source (e.g. alternate current (AC), direct current (DC)) through a power cord and an electrical outlet. In one embodiment of the invention, the main system unit (507) can also contain an integrated speaker designed to generate an aural alert when the main system unit (507) determines that a change of a current position of the toilet seat (509) is desired. In another embodiment of the invention, the main system unit (507) may simply be operatively connected to an external speaker, which is also capable of generating an aural alert when the main system unit (507) similarly determines that a change of a current position of the toilet seat (509) is desired.

For the embodiment of the invention as shown in FIG. 5, the toilet (500) also has a toilet base (501) which structurally supports a toilet drain (503) and a toilet bowl (505). In one embodiment of the invention, the toilet drain (503) removes water contained by the toilet bowl (505) when a flushing operation is triggered, typically by a user pressing the flush lever (513). The toilet (500) also typically contains a water tank (511) which typically reserves a certain amount of fresh water. The water tank (511) is designed to release and send the fresh water into the toilet bowl (505) if a flushing operation is triggered, while an existing water puddle on the toilet bowl (505) is drained out through the toilet drain (503). A top portion of the water tank (511) is typically protected and enclosed by a water tank cover (515). In a preferred embodiment of the invention, the main system unit (507) of the hygienic toilet seat alert system is attached to a top surface of the water tank cover (515).

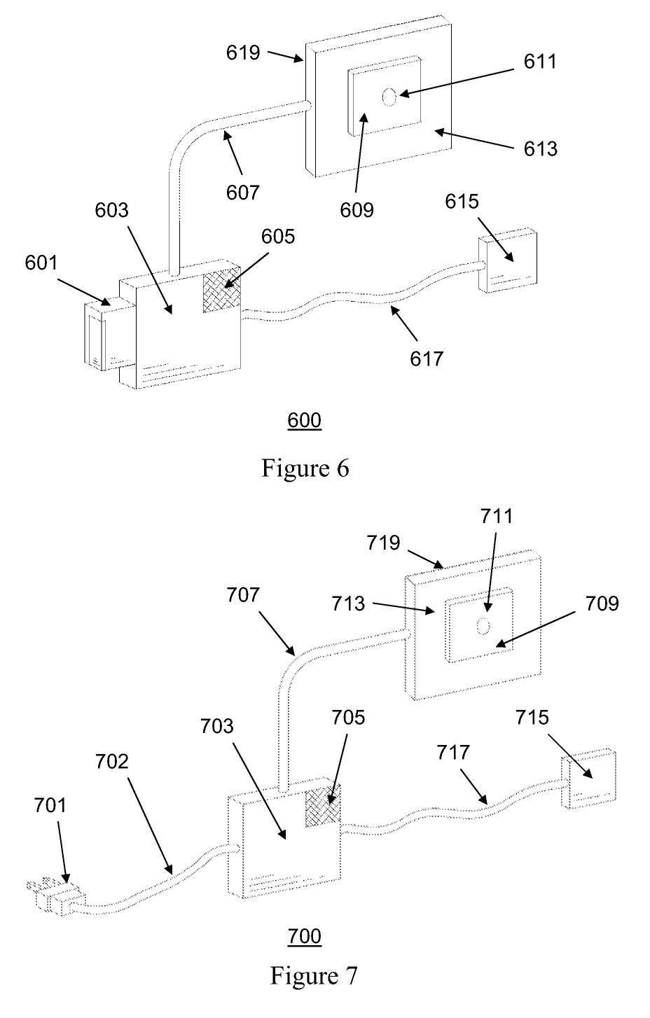

FIG. 6 shows a perspective view of a hygienic toilet seat alert system (600) with a battery casing (601), a toilet seat position sensor (615), and a user proximity sensor (619), which are operatively connected to a main system unit (603) in accordance with an embodiment of the invention. In a preferred embodiment of the invention, the battery casing (601) is capable of containing one or more batteries to provide an electrical power to the main system unit (603), the user proximity sensor (619), and the toilet seat position sensor (615). In one embodiment of the invention, the user proximity sensor (619) and/or the toilet seat position sensor (615) may be connected to the main system unit (603) through electrical wires (e.g. a first electrical wire (617) between the main system unit (603) and the toilet seat position sensor (615), a second electrical wire (607) between the main system unit (603) and the user proximity sensor (619), and etc.). In another embodiment of the invention, the user proximity sensor (619) and/or the toilet seat position sensor (615) may be wirelessly connected to the main system unit (603). In a preferred embodiment of the invention, a system speaker (605) capable of generating an aural alert is integrated into a casing of the main system unit (603) for the hygienic toilet seat alert system (600).

In a preferred embodiment of the invention, the user proximity sensor (619) comprises a proximity detector (609), a proximity sensor operational indicator (611), and a proximity sensor frame (613). The proximity detector (609) is generally capable of sensing an approaching or nearby objective up to a preset threshold distance. The proximity detector (609) may comprise an infrared sensing mechanism, a laser or optical distance-measurement-based sensing mechanism, or other available mechanisms for detecting an approaching object. In one embodiment of the invention, a threshold distance may be adjusted through a user interface (e.g. a knob, a switch, a software-driven touch-sensitive display screen, and etc.), wherein the adjustment of the threshold distance may involve changing detection sensitivities of the proximity detector (609). The proximity sensor operational indicator (611) typically indicates whether an object is currently within a threshold distance of detection or not. For example, if the proximity operational indicator (e.g. an light-emitting diode) is “on”, then the indicator may signify that a nearby object is detected within the threshold distance. If the proximity operational indicator is “off”, then the indicator may signify that no object of interest is detected within the threshold distance. In a preferred embodiment of the invention, both the proximity detector (609) and the proximity sensor operational indicator (611) are surrounded by a proximity sensor frame (613), which may be made out of plastic, rubber, or one or more metals. In one embodiment of the invention, the proximity sensor frame (613) provides an aesthetic benefit to an overall design of the user proximity sensor (619). The proximity sensor frame (613) may also provide a structural strength and/or integrity to other components (e.g. 609, 611) surrounded by the proximity sensor frame (613).

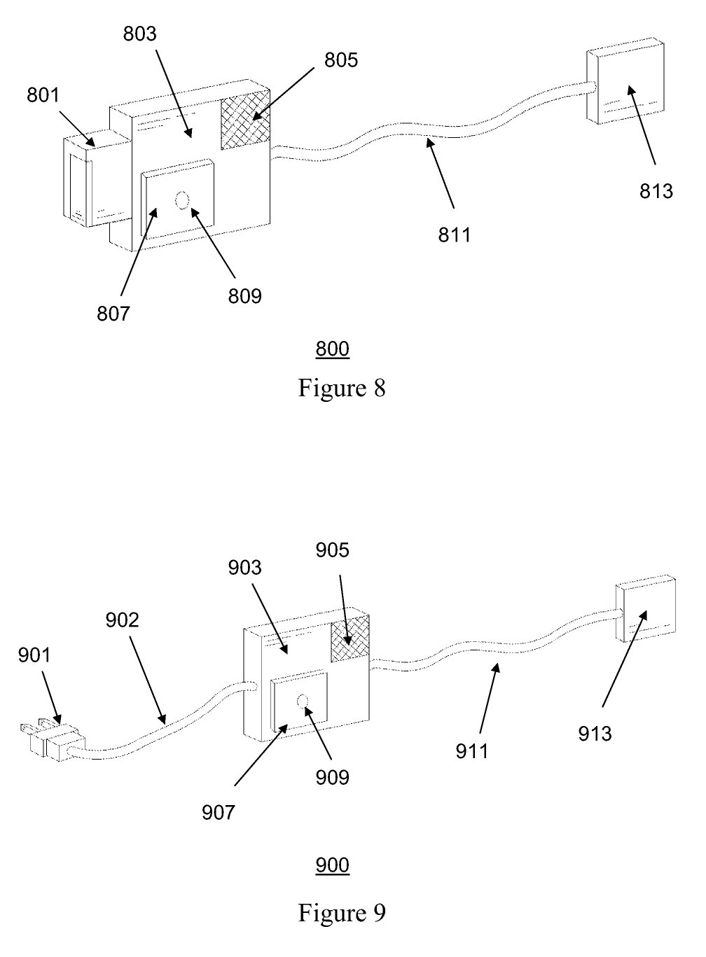

FIG. 7 shows an embodiment of a hygienic toilet seat alert system (700) with an electrical power cord (701), a user proximity sensor (719), and a toilet seat position sensor (715), which are operatively connected to a main system unit (703) in accordance with an embodiment of the invention. In a preferred embodiment of the invention, the electrical power cord (701) is configured to be plugged into an AC (alternate current) or DC (direct current) power source, such as an electrical outlet, and supplies power to the main system unit (703) through a power cord line (702). In one embodiment of the invention, the AC power source from an electrical outlet is converted into a direct current (DC) before electrical power is supplied into the main system unit (703) and/or digital logic blocks inside the main system unit (703). In another embodiment of the invention, the main system unit (703) has an integrated AC-to-DC converter and uses the converted DC current for powering at least some portions of the main system unit (703).

In one embodiment of the invention, the user proximity sensor (719) and/or the toilet seat position sensor (715) may be connected to the main system unit (703) through electrical wires (e.g. a first electrical wire (717) between the main system unit (703) and the toilet seat position sensor (715), a second electrical wire (707) between the main system unit (703) and the user proximity sensor (719), and etc.). In another embodiment of the invention, the user proximity sensor (719) and/or the toilet seat position sensor (715) may be wirelessly connected to the main system unit (703). In a preferred embodiment of the invention, a system speaker (705) capable of generating an aural alert is integrated into a casing of the main system unit (703) for the hygienic toilet seat alert system (700). In a preferred embodiment of the invention, the user proximity sensor (719) comprises a proximity detector (709), a proximity sensor operational indicator (711), and a proximity sensor frame (713). The functions and the physical configurations of these components for the user proximity sensor (719), which are represented in at least some embodiments of the present invention, are similar to descriptions of corresponding components for FIG. 5 and FIG. 6.

Although a hygienic toilet seat alert system (e.g. 600, 700) with a toilet seat position sensor and a user proximity sensor may utilize a battery-powered configuration as shown in FIG. 6, or an AC/DC powered configuration as shown in FIG. 7, it is also possible to design a hygienic toilet seat alert system which uses both the battery-powered configuration and the AC/DC powered configuration in one system.

FIG. 8 shows a perspective view of a hygienic toilet seat alert system (800) with a battery casing (801) and a toilet seat position sensor (813), which are operatively connected to a main system unit (803) containing an integrated user proximity sensor (807) and a proximity sensor operational indicator (809), in accordance with an embodiment of the invention. In a preferred embodiment of the invention, the battery casing (801) is capable of containing one or more batteries to provide an electrical power to the main system unit (803), the integrated user proximity sensor (807), and the toilet seat position sensor (813). In one embodiment of the invention, the toilet seat position sensor (813) may be connected to the main system unit (803) through an electrical wire (811). In another embodiment of the invention, the toilet seat position sensor (813) may be wirelessly connected to the main system unit (803). In a preferred embodiment of the invention, a system speaker (805) capable of generating an aural alert is integrated into a casing of the main system unit (803) for the hygienic toilet seat alert system (800).

In a preferred embodiment of the invention, the integrated user proximity sensor (807) comprises a proximity detector and a proximity sensor operational indicator. As described previously in other drawings, the proximity detector is generally capable of sensing an approaching or nearby objective up to a preset threshold distance. The proximity detector may comprise an infrared sensing mechanism, a laser or optical distance-measurement-based sensing mechanism, or other available mechanisms for detecting an approaching object. In one embodiment of the invention, a threshold distance may be adjusted through a user interface (e.g. a knob, a switch, a software-driven touch-sensitive display screen, and etc.), wherein the adjustment of the threshold distance may involve changing detection sensitivities of the proximity detector. The proximity sensor operational indicator (809) typically indicates whether an object is currently within a threshold distance of detection or not. For example, if the proximity operational indicator (e.g. an light-emitting diode) is “on”, then the indicator may signify that a nearby object is detected within the threshold distance. If the proximity operational indicator is “off”, then the indicator may signify that no object of interest is detected within the threshold distance.

FIG. 9 shows an embodiment of a hygienic toilet seat alert system (900) with an electrical power cord (901) and a toilet seat position sensor (913), which are operatively connected to a main system unit (903) containing an integrated user proximity sensor (907) and a proximity sensor operational indicator (909), in accordance with an embodiment of the invention. In a preferred embodiment of the invention, the electrical power cord (901) is configured to be plugged into an AC (alternate current) or DC (direct current) power source, such as an electrical outlet, and supplies power to the main system unit (903) through a power cord line (902). In one embodiment of the invention, the AC power source from an electrical outlet is converted into a direct current (DC) before electrical power is supplied into the main system unit (903) and/or digital logic blocks inside the main system unit (903). In another embodiment of the invention, the main system unit (903) has an integrated AC-to-DC converter and uses the converted DC current for powering at least some portions of the main system unit (903).

In one embodiment of the invention, the toilet seat position sensor (913) may be connected to the main system unit (903) through an electrical wires (911). In another embodiment of the invention, the toilet seat position sensor (913) may be wirelessly connected to the main system unit (903). In a preferred embodiment of the invention, a system speaker (905) capable of generating an aural alert is integrated into a casing of the main system unit (903) for the hygienic toilet seat alert system (900). In a preferred embodiment of the invention, the integrated user proximity sensor (907) comprises a proximity detector and a proximity sensor operational indicator (909). The functions and the physical configurations of these components for the integrated user proximity sensor (907), which are represented in at least some embodiments of the present invention, are similar to descriptions of corresponding components for FIG. 5 and FIG. 6.

Although a hygienic toilet seat alert system (e.g. 800, 900) with a toilet seat position sensor and an integrated user proximity sensor may utilize a battery-powered configuration as shown in FIG. 8, or an AC/DC powered configuration as shown in FIG. 9, it is also possible to design a hygienic toilet seat alert system which uses both the battery-powered configuration and the AC/DC powered configuration in one system.

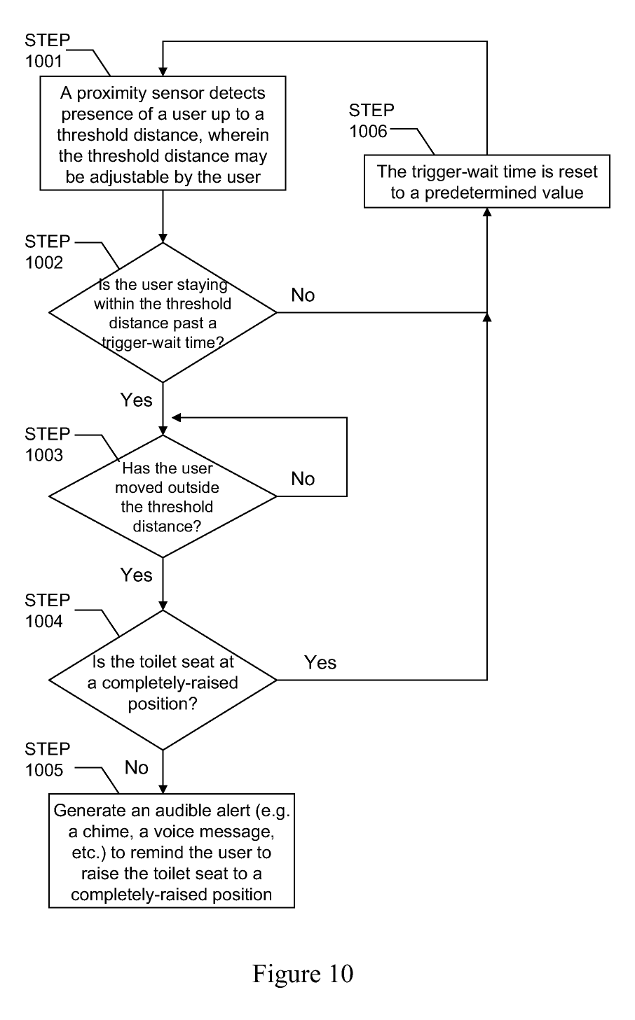

FIG. 10 shows a method of providing a hygienic toilet seat by using a hygienic toilet seat alert system with a proximity sensor and a toilet seat position sensor, in accordance with an embodiment of the invention. In one embodiment of the invention as shown in FIG. 10, a proximity sensor detects presence of a user up to a threshold distance, wherein the threshold distance may be adjustable by the user, as shown in STEP 1001. The threshold distance may be adjusted through a user interface (e.g. a knob, a switch, a software-driven touch-sensitive display screen, and etc.), wherein the adjustment of the threshold distance may involve changing detection sensitivities of a proximity detector within the proximity sensor. Then, if the user is staying within the threshold distance past a trigger-wait time, as shown in STEP 1002, then the hygienic toilet alert system assumes that the user is using a toilet and activates an alert announcement mode. Subsequently, when the user moves outside of the threshold distance, as shown in STEP 1003, the hygienic toilet alert system checks whether the toilet seat is at a completely-raised position or not, as shown in STEP 1004. If the toilet seat is not at the completely-raised position, then, the hygienic toilet alert system generates an audible alert (e.g. a chime, a voice message, and etc.) to remind the user to raise the toilet seat to the completely-raised position, as shown in STEP 1005. In contrast, if the toilet seat is at the completely-raised position at the time of checkup in STEP 1004, then the trigger-wait time may be reset to a predetermined value, as shown in STEP 1006.

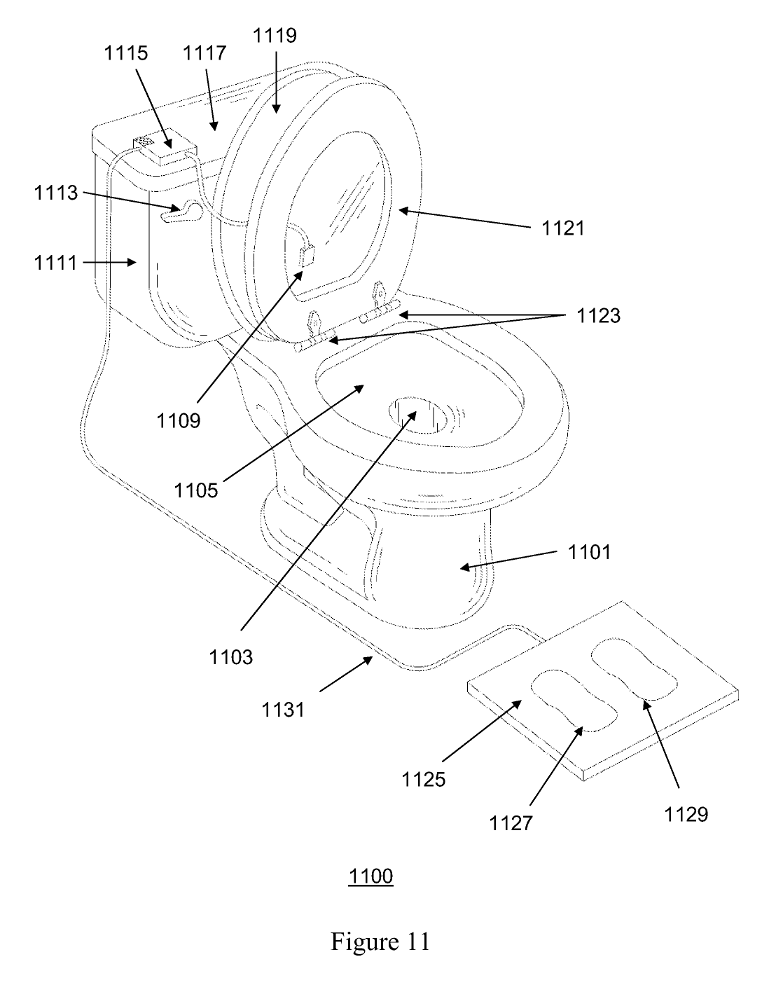

FIG. 11 shows a frontal perspective view of a hygienic toilet seat alert system with a foot-position mattress (1125) and a toilet seat position sensor (1109) installed on or near a toilet (1100), in accordance with an embodiment of the invention. In a preferred embodiment of the invention, a main system unit (1115) of the hygienic toilet seat alert system is configured to receive, analyze, and/or process information from one or more sensors (1109, 1125) operatively connected to the main system unit (1115). The main system unit (1115) typically contains one or more electrical logic blocks on one or more semiconductor chips, wherein the one or more electrical logic blocks may be able to regulate and provide operating power to the one or more sensors (1109, 1125), control functions of the hygienic toilet seat alert system, and/or generate an aural alert if necessary. In one embodiment of the invention as shown in FIG. 11, the main system unit (1115) is operatively connected to a toilet seat position sensor (1109). The toilet seat position sensor (1109) is designed to detect a current position of a toilet seat (1121), which may be at a completely-raised position, a completely-lowered position, or somewhere in between. In one embodiment of the invention, the toilet seat position sensor (1109) may contain a proximity sensor capable of detecting how close or how far the toilet seat (1121) is currently positioned relative to a location of the toilet seat position sensor (1109). In another embodiment of the invention, the toilet seat position sensor (1109) may simply be a physical contact sensor, wherein a position of the toilet seat (1121) is detected by a physical contact of the toilet seat position sensor (1109) and another object, such as a portion of the toilet seat (1121) itself or another object.

Furthermore, the main system unit (1115) can also be operatively connected to an additional sensing device. In one embodiment of the invention as shown in FIG. 11, the additional sensing device is one or more foot-position sensors (1127, 1129) which may be embedded on a foot-position mattress (1125). In a preferred embodiment of the invention, the one or more foot-position sensors (1127, 1129) may comprise an infrared sensing mechanism, a weight-sensing mechanism, and/or other available mechanisms for detecting a presence of at least one foot and a toe orientation of at least one foot.

The toilet seat position sensor (1109) and the one or more foot-position sensors (1127, 1129) may be physically connected by wires (i.e. 1131) or wirelessly connected with the main system unit (1115). In a preferred embodiment of the invention, the one or more foot-position sensors (1127, 1129) are embedded in the foot-position mattress (1125), as shown in FIG. 11. In another embodiment of the invention, the main system unit (1115) may be integrated into the foot-position mattress (1125). Furthermore, in a preferred embodiment of the invention, the toilet seat position sensor (1109) is attached to a surface of a toilet bowl cover (1119). In an alternate embodiment of the invention, the toilet seat position sensor (1109) may be attached to a surface of the toilet seat (1121) itself or another surface near toilet seat hinges (1123).

Continuing with FIG. 11, the main system unit (1115) of the hygienic toilet seat alert system can be powered by batteries or electrical power source (e.g. alternate current (AC), direct current (DC)) through a power cord and an electrical outlet. In one embodiment of the invention, the main system unit (1115) can also contain an integrated speaker designed to generate an aural alert when the main system unit (1115) determines that a change of a current position of the toilet seat (1121) is desired. In another embodiment of the invention, the main system unit (1115) may simply be operatively connected to an external speaker, which is also capable of generating an aural alert when the main system unit (1115) similarly determines that a change of a current position of the toilet seat (1121) is desired.

For the embodiment of the invention as shown in FIG. 11, the toilet (1100) also has a toilet base (1101) which structurally supports a toilet drain (1103) and a toilet bowl (1105). In one embodiment of the invention, the toilet drain (1103) removes water contained by the toilet bowl (1105) when a flushing operation is triggered, typically by a user pressing the flush lever (1113). The toilet (1100) also typically contains a water tank (1111) which typically reserves a certain amount of fresh water. The water tank (1111) is designed to release and send the fresh water into the toilet bowl (1105) if a flushing operation is triggered, while an existing water puddle on the toilet bowl (1105) is drained out through the toilet drain (1103). A top portion of the water tank (1111) is typically protected and enclosed by a water tank cover (11 17). In a preferred embodiment of the invention, the main system unit (1115) of the hygienic toilet seat alert system is attached to a top surface of the water tank cover (1117).

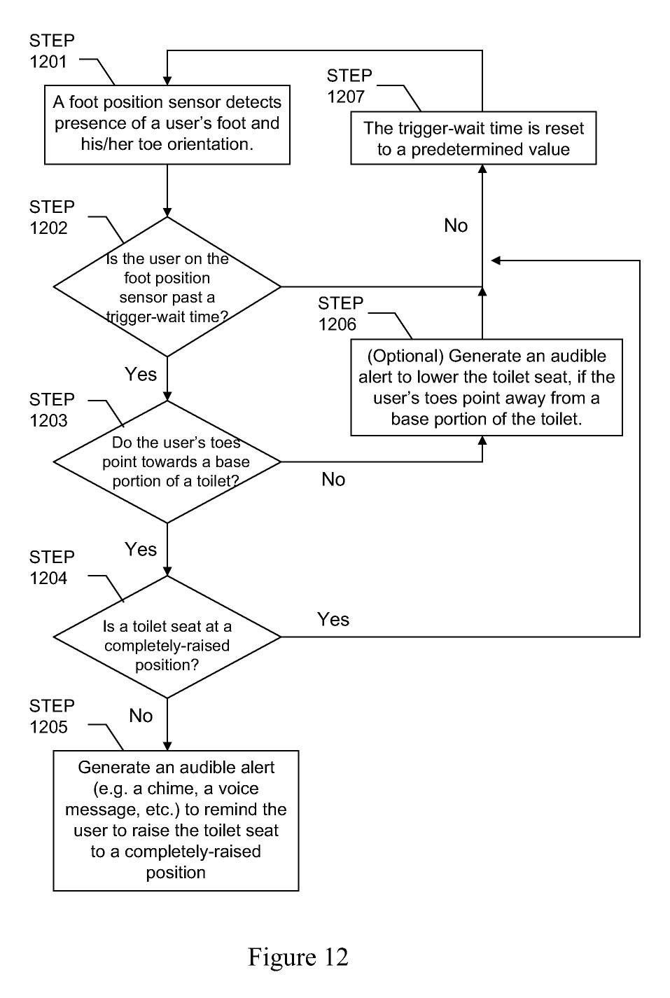

FIG. 12 shows a method of providing a hygienic toilet seat with a foot position mattress and a toilet seat position sensor as part of a hygienic toilet seat alert system, in accordance with an embodiment of the invention. As shown in STEP 1201, when a user steps on a foot position sensor, typically embedded in a foot position mattress, the foot position sensor detects presence of a user's foot and his/her toe orientation. Then, in STEP 1202, the hygienic toilet seat alert system checks whether the user's foot stayed on the foot position sensor past a trigger-wait time. This trigger-wait time check minimizes potential false alerts and false detection by the hygienic toilet seat alert system, because a user simply walking past the foot position sensor instead of staying on it for a certain amount of time (i.e. the trigger-wait time) is most likely not using the toilet. Therefore, if the user's foot is determined to leave the foot position sensor before the trigger-wait time is reached, then the trigger-wait time is simply reset to a predetermined value, as shown in STEP 1207, and the process starts over from STEP 1201.

On the other hand, if the user is staying on the foot position sensor past the trigger wait time, then the user is most likely using the toilet. Therefore, if the user's foot is determined to be on the foot position sensor past the trigger-wait time, then the hygienic toilet seat alert system checks whether the user's toes point towards a base portion of a toilet, as shown in STEP 1203. If the user's toes point towards the base portion of the toilet, then the hygienic toilet seat alert system determines that the user is most likely a male standing on the foot position sensor prior to an upright-position urination, which prompts the hygienic toilet seat alert system to check whether a toilet seat is at a completely-raised position, as shown in STEP 1204. If the toilet seat is not at the completely-raised position, then the hygienic toilet seat alert system generates an audible alert (e.g. a chine, a voice message, and etc.) to remind the user to raise the toilet seat to the completely-raised position as shown in STEP 1205, so that the male user standing on the foot position sensor prior to the upright-position urination does not accidentally urinate on a surface of the toilet seat. On the other hand, if the toilet seat is already at the completely-raised position, then the hygienic toilet seat alert system simply resets the trigger-wait time to a predetermined value, as shown in STEP 1207.

In STEP 1203, if the user's toes pointed away from the base portion of the toilet instead of pointing towards the base portion of the toilet, then the user is likely to be preparing to sit down on the toilet seat. Therefore, as an optional step, the hygienic toilet seat alert system may generate an audible alert to lower the toilet seat, as shown in STEP 1206. Then, the trigger-wait time can be reset to a predetermined value, as shown in STEP 1207.

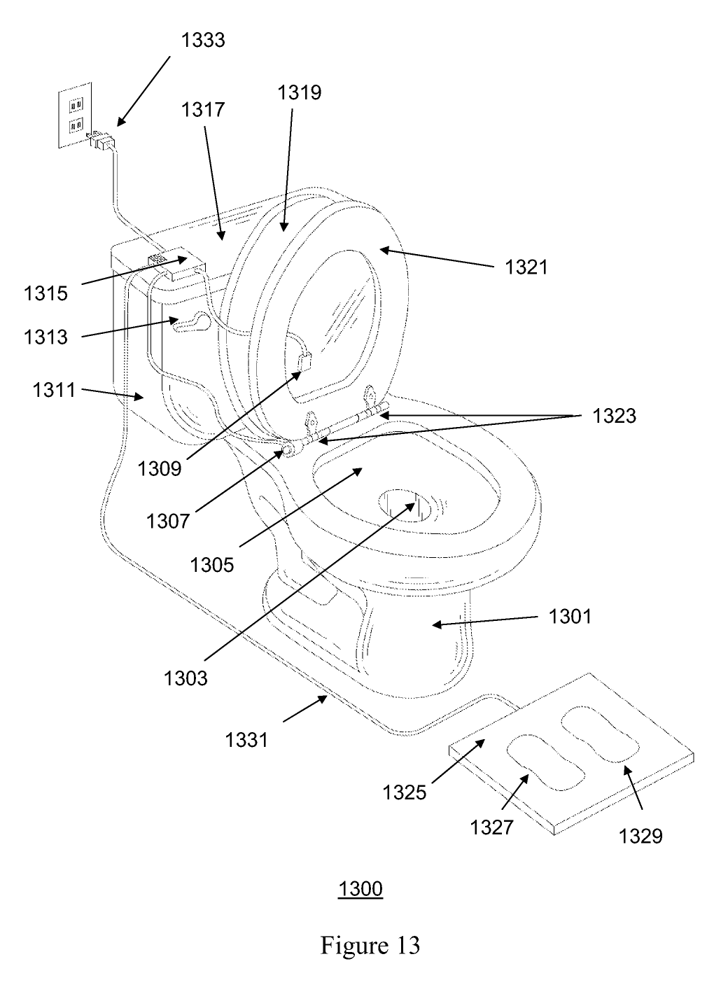

FIG. 13 shows a frontal perspective view of a hygienic toilet seat alert system with a foot-position mattress (1325), a toilet seat motor (1307), and a toilet seat position sensor (1309) installed on or near a toilet (1300), in accordance with an embodiment of the invention. In a preferred embodiment of the invention, a main system unit (1315) of the hygienic toilet seat alert system is configured to receive, analyze, and/or process information from one or more sensors (1309, 1325) operatively connected to the main system unit (1315). The main system unit (1315) typically contains one or more electrical logic blocks on one or more semiconductor chips, wherein the one or more electrical logic blocks may be able to regulate and provide operating power to the one or more sensors (1309, 1325), control functions of the hygienic toilet seat alert system, and/or generate an aural alert if necessary. In one embodiment of the invention as shown in FIG. 13, the main system unit (1315) is operatively connected to a toilet seat position sensor (1309). The toilet seat position sensor (1309) is designed to detect a current position of a toilet seat (1321), which may be at a completely-raised position, a completely-lowered position, or somewhere in between. In one embodiment of the invention, the toilet seat position sensor (1309) may contain a proximity sensor capable of detecting how close or how far the toilet seat (1321) is currently positioned relative to a location of the toilet seat position sensor (1309). In another embodiment of the invention, the toilet seat position sensor (1309) may simply be a physical contact sensor, wherein a position of the toilet seat (1321) is detected by a physical contact of the toilet seat position sensor (1309) and another object, such as a portion of the toilet seat (1321) itself or another object.

Furthermore, the main system unit (1315) can also be operatively connected to an additional sensing device. In one embodiment of the invention as shown in FIG. 13, the additional sensing device is one or more foot-position sensors (1327, 1329) which may be embedded on a foot-position mattress (1325). In a preferred embodiment of the invention, the one or more foot-position sensors (1327, 1329) may comprise an infrared sensing mechanism, a weight-sensing mechanism, and/or other available mechanisms for detecting a presence of at least one foot and a toe orientation of at least one foot.

The toilet seat position sensor (1309) and the one or more foot-position sensors (1327, 1329) may be physically connected (i.e. 1331) by wires or wirelessly connected with the main system unit (1315). In a preferred embodiment of the invention, the one or more foot-position sensors (1327, 1329) are embedded in the foot-position mattress (1325), as shown in FIG. 13. In another embodiment of the invention, the main system unit (1315) may be integrated into the foot-position mattress (1325). Furthermore, in a preferred embodiment of the invention, the toilet seat position sensor (1309) is attached to a surface of a toilet bowl cover (1319). In an alternate embodiment of the invention, the toilet seat position sensor (1309) may be attached to a surface of the toilet seat (1321) itself or another surface near toilet seat hinges (1323).

In one embodiment of the invention, a toilet seat motor (1307) is operatively connected or embedded in the toilet seat hinges (1323). The toilet seat motor (1307) is typically powered by an electrical power cord (1333) plugged into an electrical power outlet and can provide rotational forces to the toilet seat hinges (1323) to raise or lower the toilet seat (1321). In a preferred embodiment of the invention, the electrical power operation of the toilet seat (1321) enabled by the toilet seat motor (1307) is completely or largely automated, starting with a detection of a user's foot and his/her toe orientation relative to the toilet base (1301) (e.g. pointing towards the toilet base, pointing away from the toilet base, and etc.), sensing and determining other variables such as a current position of the toilet seat (1321), and initiating a power operation to either raise or lower the toilet seat (1321) if the system main unit (1315) determines that a position change of the toilet seat (1321) is desired.

Continuing with FIG. 13, the main system unit (1315) of the hygienic toilet seat alert system can be powered by batteries or electrical power source (e.g. alternate current (AC), direct current (DC)) through a power cord (1333) and an electrical outlet. In one embodiment of the invention, the main system unit (1315) can also contain an integrated speaker designed to generate an aural alert when the main system unit (1315) determines that a change of a current position of the toilet seat (1321) is desired. In another embodiment of the invention, the main system unit (1315) may simply be operatively connected to an external speaker, which is also capable of generating an aural alert when the main system unit (1315) similarly determines that a change of a current position of the toilet seat (1321) is desired.

For the embodiment of the invention as shown in FIG. 13, the toilet (1300) also has a toilet base (1301) which structurally supports a toilet drain (1303) and a toilet bowl (1305). In one embodiment of the invention, the toilet drain (1303) removes water contained by the toilet bowl (1305) when a flushing operation is triggered, typically by a user pressing the flush lever (1313). The toilet (1300) also typically contains a water tank (1311) which typically reserves a certain amount of fresh water. The water tank (1311) is designed to release and send the fresh water into the toilet bowl (1305) if a flushing operation is triggered, while an existing water puddle on the toilet bowl (1305) is drained out through the toilet drain (1303). A top portion of the water tank (1311) is typically protected and enclosed by a water tank cover (1317). In a preferred embodiment of the invention, the main system unit (1315) of the hygienic toilet seat alert system is attached to a top surface of the water tank cover (1317).

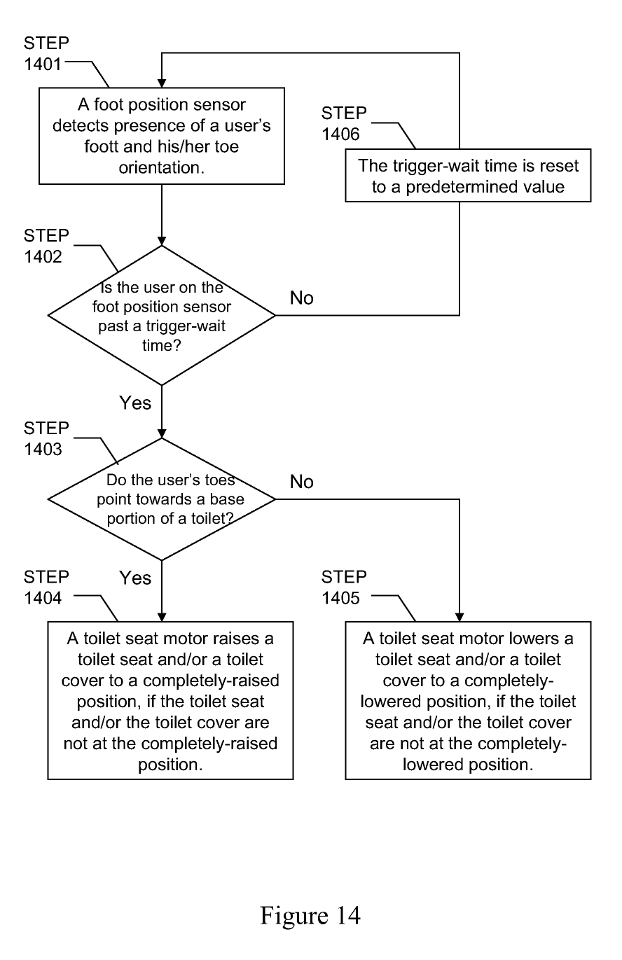

FIG. 14 shows a method of providing a motorized hygienic toilet seat with a foot-position mattress, a toilet seat motor, and a toilet seat position sensor, in accordance with an embodiment of the invention. As shown in STEP 1401, when a user steps on a foot position sensor, typically embedded in a foot position mattress, the foot position sensor detects presence of a user's foot and his/her toe orientation. Then, in STEP 1402, the hygienic toilet seat alert system checks whether the user's foot stayed on the foot position sensor past a trigger-wait time. This trigger-wait time check minimizes potential false alerts and false detection by the hygienic toilet seat alert system, because a user simply walking past the foot position sensor instead of staying on it for a certain amount of time (i.e. the trigger-wait time) is most likely not using the toilet. Therefore, if the user's foot is determined to leave the foot position sensor before the trigger-wait time is reached, then the trigger-wait time is simply reset to a predetermined value, as shown in STEP 1406, and the process starts over from STEP 1401.

On the other hand, if the user is staying on the foot position sensor past the trigger wait time, then the user is most likely using the toilet. Therefore, if the user's foot is determined to be on the foot position sensor past the trigger-wait time, then the hygienic toilet seat alert system checks whether the user's toes point towards a base portion of a toilet, as shown in STEP 1403. If the user's toes point towards the base portion of the toilet, then the hygienic toilet seat alert system determines that the user is most likely a male standing on the foot position sensor prior to an upright-position urination, which prompts the hygienic toilet seat alert system to utilize its toilet seat motor to raise a toilet seat and/or a toilet bowl cover to a completely-raised position, if the toilet seat and/or the toilet bowl cover are not already at the completely-raised position, as shown in STEP 1404. During a power operation of raising the toilet seat, the hygienic toilet seat alert system can also generate an audible alert that the toilet seat is in a process of changing its position.

On the other hand, if the user's toes are determined to point away from the base portion of the toilet in STEP 1403, then a user is likely to sit down on the toilet seat sometime soon. Therefore, the toilet seat motor can lower the toilet seat and/or the toilet bowl cover to a completely-lowered position, if the toilet seat and/or the toilet bowl cover are not already at the completely-lowered position, as shown in STEP 1405. During a power operation of lowering the toilet seat, the hygienic toilet seat alert system can also generate an audible alert that the toilet seat is in a process of changing its position.

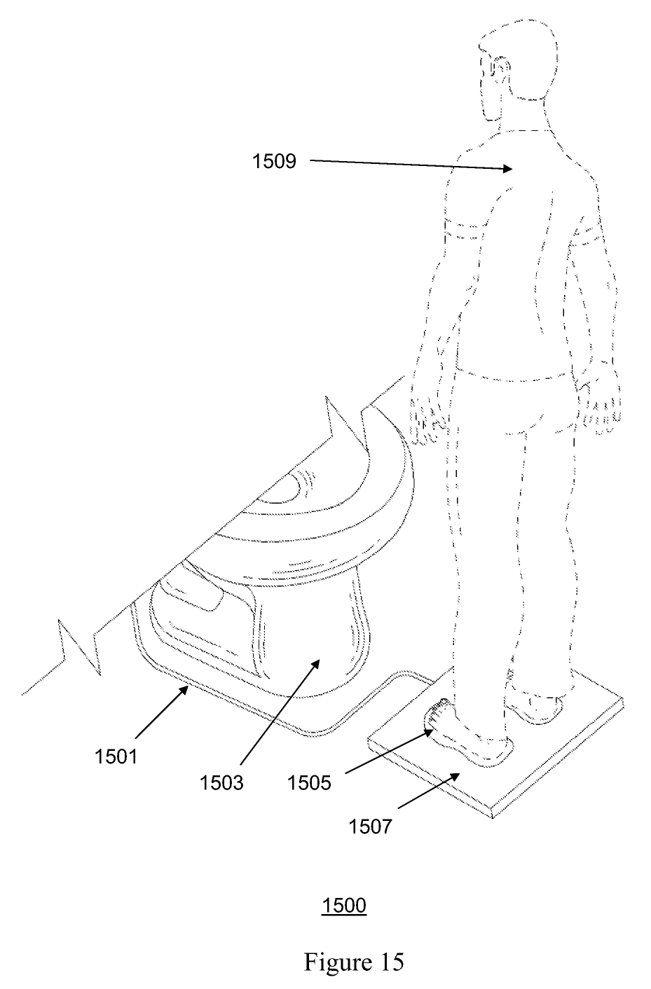

FIG. 15 shows an illustrative example (1500) of a user (1509) standing on top of a foot-position mattress (1507) with the user's toes “pointing towards” (1505) a toilet base (1503), in accordance with an embodiment of the invention. In one embodiment of the invention, the foot position mattress (1507) embeds one or more foot-position sensors. Furthermore, in one embodiment of the invention, the foot position mattress (1507) is operatively connected to a system main unit of a hygienic toilet seat alert system using an electrical connection (1501). In another embodiment of the invention, the foot position mattress (1507) can also be operatively connected to the system main unit via a wireless connection. The foot position mattress (1507) can be used for an embodiment of a hygienic toilet seat alert system without a toilet seat motor, as illustrated by FIGS. 11 12, or for another embodiment of a the hygienic toilet seat alert system with the toilet seat motor, as illustrated by FIGS. 13 14.

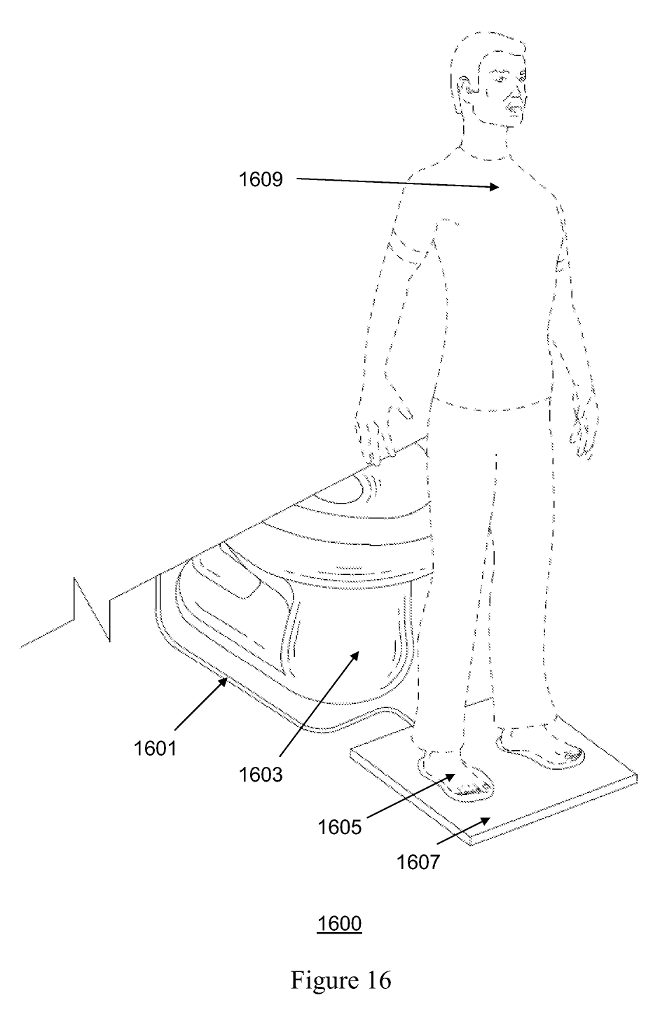

FIG. 16 shows an illustrative example (1600) of a user (1609) standing on top of a foot-position mattress (1607) with the user's toes “pointing away” (1605) from a toilet base (1603), in accordance with an embodiment of the invention. In one embodiment of the invention, the foot position mattress (1607) embeds one or more foot-position sensors. Furthermore, in one embodiment of the invention, the foot position mattress (1607) is operatively connected to a system main unit of a hygienic toilet seat alert system using an electrical connection (1601). In another embodiment of the invention, the foot position mattress (1607) can also be operatively connected to the system main unit via a wireless connection. The foot position mattress (1607) can be used for an embodiment of a hygienic toilet seat alert system without a toilet seat motor, as illustrated by FIGS. 11˜12, or for another embodiment of a the hygienic toilet seat alert system with the toilet seat motor, as illustrated by FIGS. 13˜14.

Several apparatuses and methods for providing one or more hygienic toilet seats have been disclosed in the detailed description of the invention. One advantage of the present invention is providing a multi-age-friendly and multi-gender-friendly hygienic toilet seat alert system for residential household consumers. Another advantage of the present invention is durability and low cost of designing and manufacturing one or more embodiments of the present invention as an aftermarket “add-on” solution or a factory-installed new toilet device. Yet another advantage of the present invention is an operational simplicity of the hygienic toilet seat alert system incorporating at least one embodiment of the present invention. Yet another advantage of the present invention is a relatively easy device maintenance for apparatuses incorporating at least one embodiment of the present invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A hygienic toilet alert system configured to inform a user to change a current position of a toilet seat if necessary, the hygienic toilet alert system comprising:
a toilet seat position sensor configured to detect the current position of the toilet seat, wherein the toilet seat position sensor is operatively connected to a main system unit;
an additional sensing device capable of sensing a flushing operation and a status related to the flushing operation, a nearby user up to a threshold distance, and/or a user's particular foot position, wherein the additional sensing device may be a flush sensor, a proximity sensor, and/or a foot-position mattress with one or more foot-position sensors; and
the main system unit operatively connected to the toilet seat position sensor and the additional sensing device, wherein the main system unit is capable of analyzing information from the toilet seat position sensor and the additional sensing device to determine whether an aural alert needs to be generated to inform the user to change the current position of the toilet seat.

2. The apparatus of claim 1, wherein the flush sensor is attached near or on top of a flush lever of a toilet.

3. The apparatus of claim 1, wherein the proximity sensor is integrated into the main system unit, separately attached on top of a water tank of a toilet, or separately attached on a nearby wall to the toilet.

4. The apparatus of claim 1, wherein the foot-position mattress with the one or more foot-position sensors are capable of detecting the user's particular foot position by analyzing whether user's toes are pointing towards a toilet base or away from the toilet base.

5. The apparatus of claim 1, further comprising a toilet seat motor operatively connected to one or more hinges of the toilet seat, wherein the toilet seat motor is capable of raising the toilet seat to a completely-raised position or to a completely-lowered position based on an output command provided by the main system unit.

6. The apparatus of claim 1, wherein the toilet seat position sensor is attached on a surface of a toilet bowl cover or a surface of a toilet seat.

7. The apparatus of claim 1, wherein the main system unit integrates a speaker to transmit the aural alert to the user.

8. The apparatus of claim 3, wherein the proximity sensor is operatively connected to an adjustable knob or an interface to change a current value of the threshold distance.

9. The apparatus of claim 1, wherein the main system unit is operatively connected to a battery case and/or an electrical power cord to receive electrical power for an operation of the hygienic toilet alert system.

10. The apparatus of claim 1, wherein the proximity sensor comprises a proximity sensor operational indicator, a proximity detector unit, and a proximity sensor frame.

11. A method for providing a hygienic toilet seat, the method comprising the steps of:
using a flush sensor to detect a flush operation initiated by a user;
detecting a current position of a toilet seat using a toilet seat position sensor; and
if the toilet seat is not at a completely-raised position:
generating an aural alert such as a chime, a bell, and/or a voice message to remind the user to raise the toilet seat to a completely-raised position.

12. The method of claim 11, further comprising a step of waiting for a detection of a next flush operation by the user.

13. A method for providing a hygienic toilet seat, the method comprising the steps of:
using a proximity sensor to detect presence of a user up to a threshold distance, wherein the threshold distance may be adjustable by the user; and
if the user is staying within the threshold distance past a trigger-wait time and then moved outside the threshold distance some time after the trigger-wait time:
checking whether the toilet seat is at a completely-raised position; and
if the toilet seat is not at the completely-raised position:
generating an aural alert such as a chime, a bell, and/or a voice message to remind the user to raise the toilet seat to the completely-raised position.

14. The method of claim 13, further comprising a step of resetting the trigger-wait time to a predetermined value.

15. A method for providing a hygienic toilet seat, the method comprising the steps of:
using a foot-position sensor to detect presence of a user's foot and a user's toe orientation; and
if the user on the foot-position sensor is past a trigger-wait time and if the user's toes point towards a toilet base:
checking whether the toilet seat is at a completely-raised position; and
if the toilet seat is not at the completely-raised position:
generating an aural alert such as a chime, a bell, and/or a voice message to remind the user to raise the toilet seat to the completely-raised position.

16. The method of claim 15, further comprising a step of resetting the trigger-wait time to a predetermined value.

17. The method of claim 15, further comprising a step of generating an aural alert to lower the toilet seat to a completely-lowered position if the user on the foot-position sensor is past the trigger-wait time and if the user's toes point away from the toilet base.

18. A method for providing a hygienic toilet seat, the method comprising the steps of:
using a foot-position sensor to detect presence of a user's foot and a user's toe orientation; and
if the user on the foot-position sensor is past a trigger-wait time and if the user's toes point towards a toilet base:
checking whether the toilet seat is at a completely-raised position; and
if the toilet seat is not at the completely-raised position:
raising the toilet seat and/or a toilet bowl cover to the completely-raised position by using a toilet seat motor;
else if the user on the foot-position sensor is past the trigger-wait time and if the user's toes point away from the toilet base:
checking whether the toilet seat is at a completely-lowered position; and
if the toilet seat is not at the completely-lowered position:
lowering the toilet seat and/or the toilet bowl cover to the completely-lowered position by using the toilet seat motor.

19. The method of claim 18, further comprising a step of resetting the trigger-wait time to a predetermined value.

20. The method of claim 18, wherein the foot-position sensor is part of a foot-position mattress.
